(19) United States
(12) Patent Application Publication
(10) Pub. No.: US 2013/0015046 A1
(43) Pub. Date: Jan. 17, 2013

(54) MECHANICAL TYPE CONTROL PANEL OF AN EXERCISE EQUIPMENT

(71) Applicant: WEI-CHUN CHANG, Taichung City (TW)

(72) Inventor: WEI-CHUN CHANG, Taichung City (TW)

(73) Assignee: P & F BROTHER INDUSTRIAL CORPORATION, TAICHUNG CITY (TW)

(21) Appl. No.: 13/183,258

(22) Filed: Jul. 14, 2011

(51) Int. Cl. H01H 13/76

(52) U.S. Cl. 200/5 A

(57) ABSTRACT

A mechanical type control panel of an exercise equipment comprises a light source layer, a light-transmitting cover layer, and a film button layer, which employs the light-on button with a turned-on backlight to guide the user to press so as to reduce the possibility of pressing the wrong buttons, and also to enable the user to use the control panel to do the setting of the exercise equipment even in a dim environment. On top of that, the light-transmitting cover layer enables the light of the light emitting elements to be smoothly distributed to the buttons, so as to provide a better sense of the look of the buttons.

### BACKGROUND OF THE INVENTION

1. Field of the Invention

The present invention relates to a control panel of an exercise equipment, and more particularly to a mechanical type control panel of an exercise equipment.

2. Description of the Prior Art

Exercise equipments are usually provided with a control panel, and on the control panel are arranged a plurality of buttons for setting different functions. For example, the control panel of a treadmill machine is usually provided with buttons for controlling speed, gradient, time, distance, calories, and etc.

Currently, control panel generally includes high-cost touch control panel and low-cost mechanical control panel, such as film type control panel. However, the low-cost mechanical control panel has the following disadvantages that need to be improved.

Firstly, the low-cost mechanical control panel is provided with a plurality of buttons and a display light source separated from the buttons. Therefore, it is hard to immediately tell to which button the “on” display light source corresponds, when the user presses the button, so that the user usually presses the wrong buttons.

Secondly, since the display light source is separated from other buttons, and the buttons can't produce light on their own, hence, it is impossible to use the functions key in a dark environment.

The present invention has arisen to mitigate and/or obviate the afore-described disadvantages.

### SUMMARY OF THE INVENTION

The primary object of the present invention is to a mechanical type control panel of an exercise equipment, which employs the light-on button with a turned-on backlight to guide the user to press so as to reduce the possibility of pressing the wrong buttons.

Another object of the present invention is to a mechanical type control panel of an exercise equipment, which employs the buttons and light source to enable the user to use the control panel to do the setting of the exercise equipment even in a dim environment.

Yet, another object of the present invention is to a mechanical type control panel of an exercise equipment, which is provided with a light-transmitting cover layer which enables the light of the light emitting elements to be smoothly distributed to the buttons, providing a better sense of the look of the buttons.

To achieve the above objects, a mechanical type control panel of an exercise equipment in accordance with the present invention comprises a light source layer, a light-transmitting cover layer, and a film button layer. The light source layer is provided with a plurality of light emitting elements, the light-transmitting cover layer is located above the light source layer to disperse light generated from the light emitting elements. The film button layer is provided with a circuit and a plurality of buttons electrically connected to the circuit, each of the buttons has a first light-transmitting portion, and the film button layer is located on the light-transmitting cover layer in such a manner that the first light-transmitting portions are aligned with the light emitting elements to allow passage of the light generated from the light emitting elements. The top layer is provided with a plurality of pressing areas aligned with the buttons, and each of the pressing areas has a second light-transmitting portion, the top layer is located on the film button layer in such a manner that the second light-transmitting portions are aligned with the first light-transmitting portions of the respective buttons to allow passage of the light generated from the light emitting elements.

Preferably, a stop portion is disposed between each two neighboring light emitting elements of the light source layer.

Preferably, the film button layer is made of polypropylene or Acrylonitrile Butadiene Styrene.

### BRIEF DESCRIPTION OF THE DRAWINGS

FIG. 1 is an exploded view of a mechanical type control panel for an exercise equipment in accordance with the present invention;

FIG. 2 is a cross sectional view of the mechanical type control panel for an exercise equipment in accordance with the present invention;

FIG. 3 is an operational view of the mechanical type control panel for an exercise equipment in accordance with the present invention; and

FIG. 4 is a cross sectional view of the mechanical type control panel for an exercise equipment in accordance with another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

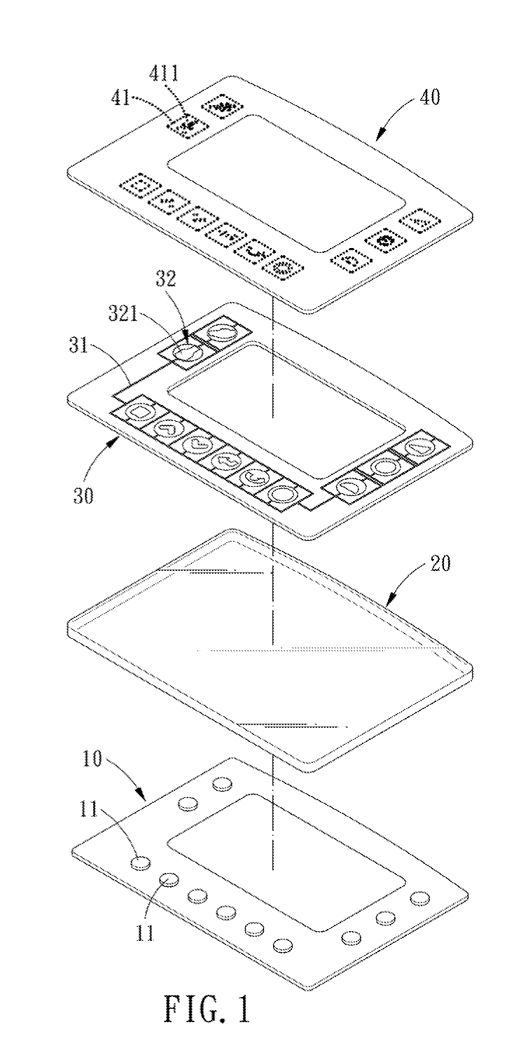

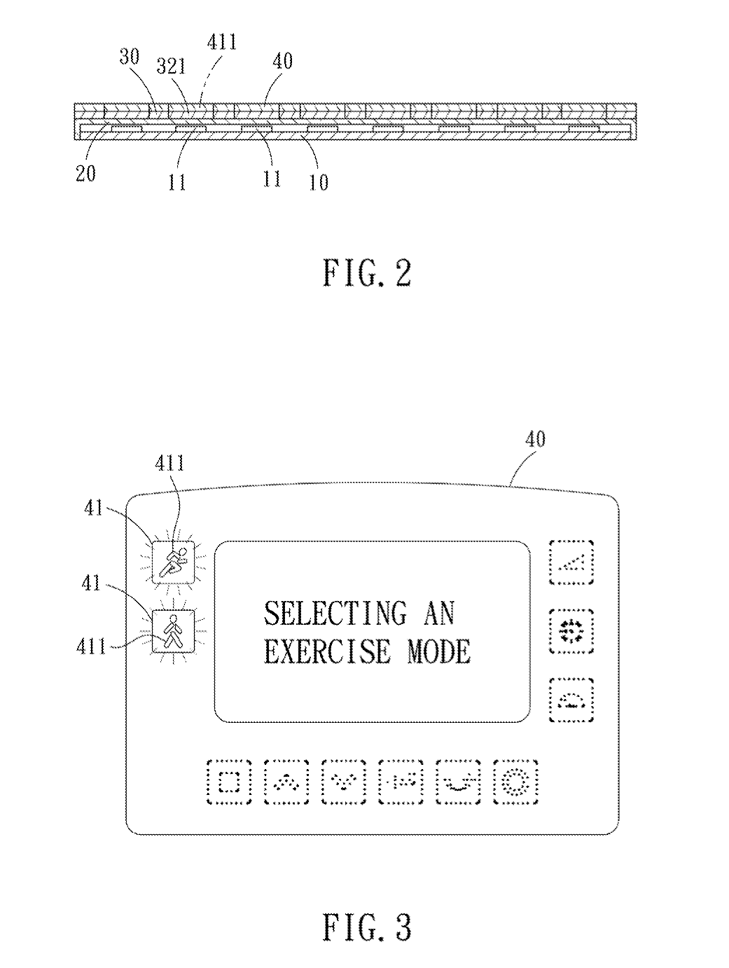

Referring to FIGS. 1 and 2, a mechanical type control panel for an exercise equipment in accordance with the present invention comprises a light source layer 10, a light-transmitting cover layer 20, a film button layer 30 and a top layer 40.

The light source layer 10 is provided with a plurality of light emitting elements 11.

The light-transmitting cover layer 20 is located above the light source layer 10 to evenly and smoothly disperse the light of the light emitting elements 11.

The film button layer 30 is provided with a circuit 31 and a plurality of buttons 32 electrically connected to the circuit 31. Each of the buttons 32 has a first light-transmitting portion 321, and the film button layer 30 is located on the light-transmitting cover layer 20 in such a manner that the first light-transmitting portions 321 are aligned with the light emitting elements 11 to allow passage of the light generated from the light emitting elements 11. The film button layer 30 is made of PP (polypropylene), ABS (Acrylonitrile Butadiene Styrene), etc, and the first light-transmitting portion 321 is an area of the button 32 defined by the circuit 31.

The top layer 40 is provided with a plurality of pressing areas 41 aligned with the buttons 32, and each of the pressing areas 41 has a second light-transmitting portion 411. The top layer 40 is located on the film button layer 30 in such a manner that the second light-transmitting portions 411 are aligned with the first light-transmitting portions 321 of the respective buttons 32 to allow passage of the light generated from the light emitting elements 11.

As shown in FIG. 3, the combination of the buttons of the control panel and the light sources enables the user to tell right way which button needs to be pressed (namely, the button with turned-on backlight needs to be pressed) when the user is setting functions or values by pressing buttons (namely, the buttons involve the buttons 32 on the film button layer 30 and the pressing areas 41 of the top layer 40 since the pressing areas 41 will inevitably be pressed when pressing the buttons 32). In this way, the light-on button with a turned-on backlight guides the user to press so as to reduce the possibility of pressing the wrong buttons and enable the user to use the control panel to do the setting of the exercise equipment even in a dim environment.

Furthermore, the light-transmitting cover layer 20 enables the light of the light emitting elements 11 to be smoothly distributed to the buttons, providing a better sense of the look of the buttons.

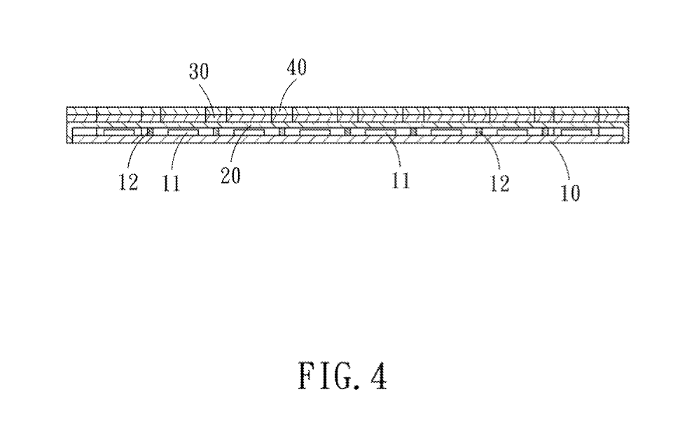

Referring then to FIG. 4, a mechanical type control panel for an exercise equipment in accordance with another embodiment of the present invention is similar to that of the above embodiment except that between each two neighboring light emitting elements 11 of the light source layer 10 is disposed a stop portion 12 to prevent the light of different light emitting elements 11 from mixing together, thus ensuring that the color of the light of the buttons on the control panel is the same as the color of the light emitted from the corresponding light emitting elements 11.

While we have shown and described various embodiments in accordance with the present invention, it is clear to those skilled in the art that further embodiments may be made without departing from the scope of the present invention.

What is claimed is:

1. A mechanical type control panel of an exercise equipment comprising:
a light source layer with a plurality of light emitting elements;
a light-transmitting cover layer located above the light source layer to disperse light generated from the light emitting elements;
a film button layer provided with a circuit and a plurality of buttons electrically connected to the circuit, each of the buttons having a first light-transmitting portion, and the film button layer being located on the light-transmitting cover layer in such a manner that the first light-transmitting portions are aligned with the light emitting elements to allow passage of the light generated from the light emitting elements;
a top layer provided with a plurality of pressing areas aligned with the buttons, and each of the pressing areas having a second light-transmitting portion, the top layer being located on the film button layer in such a manner that the second light-transmitting portions are aligned with the first light-transmitting portions of the respective buttons to allow passage of the light generated from the light emitting elements.

2. The mechanical type control panel of an exercise equipment as claimed in claim 1, wherein a stop portion is disposed between each two neighboring light emitting elements of the light source layer.

3. The mechanical type control panel of an exercise equipment as claimed in claim 1, wherein the film button layer is made of polypropylene or Acrylonitrile Butadiene Styrene.
